(19) United States
(12) Patent Application Publication
(10) Pub. No.: US 2008/0277307 A1
(43) Pub. Date: Nov. 13, 2008

(54) ELECTRONIC INTERACTIVE PILLBOX SYSTEM

(76) Inventor: Robert Mazur, Plymouth, MI (US)

Correspondence Address: BUTZEL LONG;IP DOCKETING DEPT, 350 SOUTH MAIN STREET, SUITE 300, ANN ARBOR, MI, 48104, US

(21) Appl. No.: 12/117,978

(22) Filed: May 9, 2008

Related U.S. Application Data
(60) Provisional application No. 60/928,370, filed on May 9, 2007.
(60) Provisional application No. 61/065,612, filed on Feb. 13, 2008.

(51) Int. Cl. A61J 1/03; H04R 3/00; F21V 33/00

(52) U.S. Cl. 206/534; 206/538; 381/122; 362/154

(57) ABSTRACT

An interactive electronic pillbox that includes a plurality of compartments for containing medications and means to electronically identify a particular compartment from which medication is to be taken at a particular time. The interactive electronic pillbox includes data entry, data display, data transmitting and data processing functions which allow for interactive healthcare management by individuals and healthcare personnel directly or remotely.

### RELATED APPLICATIONS

The present application is based upon and claims priority under 35 U.S.C. §120 to U.S. Provisional Application No. 60/928,370, filed May 9, 2007 and U.S. Provisional Application No. 61/065,612, filed Feb. 13, 2008, the complete disclosures of which are hereby expressly incorporated by reference.

### TECHNICAL FIELD

The present invention relates to pillboxes for storing and organizing various medications, vitamins, supplements, etc. In particular, the present invention relates to an electronic interactive pillbox system that, in addition to storing and organizing various medications, vitamins, supplements, etc., provides advanced electronic features such as data management, interactive functions, etc.

### BACKGROUND ART

Managing the medication taking process can be frustrating and confusing. Doctors prescribe multiple medications for different health conditions. Some medications might be taken daily, others twice a day, and yet others 3-4 times a day. When multiple medications are prescribed and each is to be taken at different intervals, it can become difficult to remember when each medication is to be taken and thus there is a need for a simple management system for such pill-taking.

### DISCLOSURE OF THE INVENTION

According to various features, characteristics and embodiments of the present invention which will become apparent as the description thereof proceeds, the present invention provides an interactive electronic pillbox which comprises a housing having a plurality of compartments each compartment defined by a top, an openable lid which closes the top, and a circuit board coupled to the pillbox, the circuit board including a plurality of light sources which can selectively illuminate individual ones of the plurality of compartments.

The present invention further provides a method of managing an individual's healthcare which involves:

providing an interactive electronic pillbox which includes a housing having a plurality of compartments each compartment defined by a top, an openable lid which closes the top, and a circuit board coupled to the pillbox, the circuit board including a plurality of light sources which can selectively illuminate individual ones of the plurality of compartments;

providing medications in said plurality of compartments; and

illuminating a selected one of said plurality of compartments to indicate which medication is to be taken.

The present invention also provides a method of managing an individual's healthcare which involves:

providing an individual with an interactive electronic pillbox which includes a housing having a plurality of compartments;

providing medications in the at least some of the plurality of compartments;

transmitting data from the interactive electronic pillbox to a remote site; and

allowing another party to monitor the individual's healthcare from the data transmitted to the remote site.

### BRIEF DESCRIPTION OF DRAWINGS

The present invention will be described with reference to the attached drawings which are given as non-limiting examples only, in which:

FIG. 1 is an exploded perspective view of an electronic pillbox according to one embodiment of the present invention.

FIG. 2 is side perspective view of the electronic pillbox of FIG. 1.

FIG. 3 is a side perspective view of one end of an electronic pillbox according to one embodiment of the present invention.

FIG. 4 is an enlarged exploded perspective view of an electronic pillbox according to one embodiment of the present invention.

FIG. 5 is a partial cross-sectional view of the electronic pillbox of FIG. 4 taken along sectional lines 5-5.

FIG. 6 is a cross-sectional view of one of the compartments of an electronic pillbox of the present invention which depicts how the LED's illuminate the cover of the compartment.

FIGS. 7 and 8 are cross-sectional views of one of the compartments of an electronic pillbox of the present invention which depict how the sensors 12 function to determine when the covers of the compartments have been opened.

FIG. 9 is a perspective view of the electronic pillboxes positioned in a docking station according to one embodiment of the present invention.

### BEST MODE FOR CARRYING OUT THE INVENTION

The present invention is directed to an electronic interactive pillbox system that, in addition to storing and organizing various medications, vitamins, supplements, etc., provides advanced electronic features such as data management, interactive functions, etc. The present invention allows for a person to take an active role in their health management. For example, the present invention allows an individual to record multiple questions, and while talking to a physician, nurse or other health care worker, simultaneously play the questions and record answers given by the physician, nurse or other health care worker.

Through electronic circuitry, the questions and answers to and from the physician can be stored in an electronic data file. The electronic data file can be in any convenient format. With the recorded data file, the individual can take the electronic pillbox of the present invention back to their home and through a data transfer device such as a computer interface, docking port, USB connection, wireless link, etc. the data file can be downloaded to a computer or other mobile device for recording and storage of that meeting with the physician, nurse or other health care worker.

The data transfer device can also allow the electronic pillbox to function as an electronic monitoring device. Through the use of LED's and sensors, a person can know what medication to take, when to take the medication, and if they took or missed taking a medication. In this regard, sensors will monitor if the cover of a compartment of the electronic pillbox has been opened so that the contents of the compartment has been accessed. In addition, LED's or other display devices will alert a user that it is time to take his/her medication and which medication to take. The use of different colored LED's will allow a user to know which medication to take and if they did not take the medication. For those who are color blind, the LED's could flash and/or the device can be provided with a speaker that can alert the person that it is time to take a medication or that the medication has not been taken.

A speaker and microphone provided on the electronic pillboxes of the present invention could also be used to record a personal message. For example, a caregiver or loved one can leave a voice prompt to take a medication together with words of comfort or encouragement.

The present invention incorporates a notepad, electronic display or message board to display the medications that a person is taking, as well as the dosages and frequencies. In addition, the display can display emergency contact information, whether or not a living will has been affected and the contact information of the administrator of any such living will. In addition to an onboard memory, the data transfer device can be used to transfer such information to a computer and/or transfer such information to a remote monitor, computer, data bank, etc. Further, security features can be incorporated, such as password clearance to allow caregivers, health care professionals, etc. to access and monitor such date and intervene with a patient's healthcare management when necessary.

According to one embodiment, a scanner can be included on the electronic pillboxes of the present invention and used to scan information provided on the labels on medication containers. The scanned information can be used to assist in programming the electronic pillboxes. The scanned information can also be used to provide a stored or recorded audible directive related to the information.

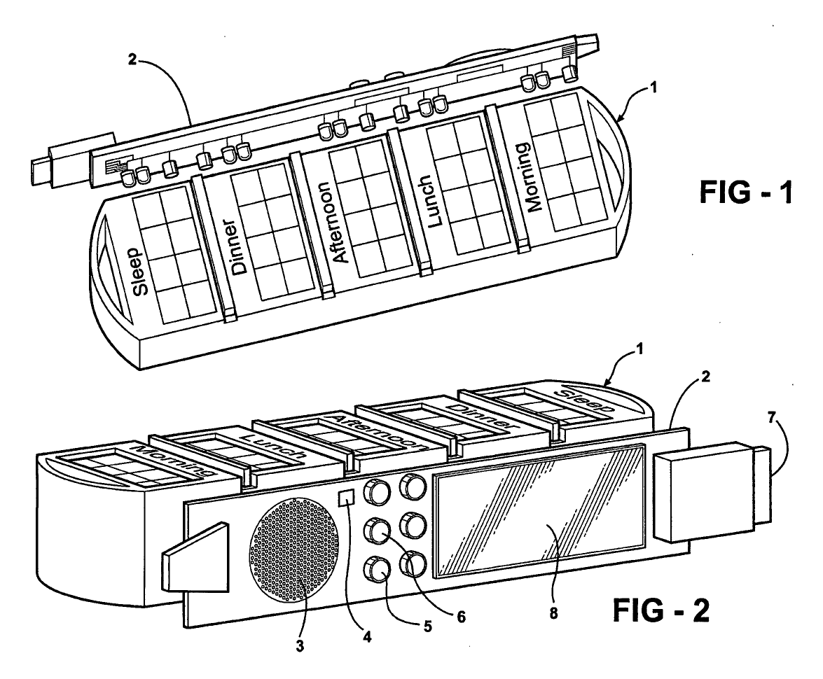

FIG. 1 is an exploded perspective view of an electronic pillbox according to one embodiment of the present invention. The electronic pillbox of the present invention includes a multi-compartment pillbox 1 and a circuit board 2 that are coupled together. The pillbox 1 is of a multi-compartment style in which each compartment has a separate or individual cover. In general, such pillbox structures are conventional. According to one embodiment, the pillbox 1 used for the present invention is disclosed in co-pending application Ser. No. 12/033,332, the complete disclosure of which is hereby expressly incorporated by reference. The pillbox 1 can include indicium that identifies individual compartments as shown and can be made from any suitable material such as plastic materials, resin materials, metals, etc.

The circuit board 2 has a number of conventional components some of which will be discussed in detail as the description of the present invention proceeds. Some of the conventional components include a programmable processor which, as discussed below, will allow the electronic pillbox to perform a number of functions related to managing an individual's medication schedule, including allowing monitoring or overseeing an individual's healthcare management by third parties.

The circuit board 2 can be formed separately and coupled to the pillbox 1 in any suitable fashion. According to alternative embodiments, some or all the components of the circuit board 2 can be formed directly into the pillbox 1 including printed circuit board components that can be printed or laminated or otherwise formed on or incorporated into the pillbox 1.

FIG. 2 is side perspective view of the electronic pillbox of FIG. 1. The circuit board 2 shown in FIG. 2 includes a speaker 3 coupled to a recording device, chip, or circuit, a microphone 4 and one or more “record” and “play back” buttons 5 and 6. The combination of the speaker 3, recording device, chip, or circuit, microphone 4 and “record” and “play back” buttons 5 and 6, allow a user to pre-record questions that he/she might want to ask a healthcare worker, such as for example “is this rash a cancer?” In addition, the combination will allow a user to record answers and comments a healthcare worker will provide during a consultation. The use of multiple “record” and “play back” buttons 5 and 6 can be used for separate questions some or all of which can be programmed into the recording device, chip, or circuit. The configuration and number of the “record” and “play back” buttons 5 and 6 can vary from that shown without departing from the scope of the present invention.

A data transfer device is provided on the circuit board to allow information to be transferred between the electronic pillbox and other devices such as a computer, docking station, mobile devices, including cell phones, pagers, interactive testing device, etc. The date transfer device can be a USB connector 7 as shown, an antenna for wireless data transfer, a connector port that receives a transfer cable, a computer interface or docking port, etc.

A display 8 is provided on the circuit board 2 which can be use to display various information such as, but not limited to, medication information, pictures or photographs, emergency contact information, text messages or messages from loved ones. The display 8 could be as simple as a writable or re-writable paper or plastic surface or an electric or digital display that can display images, including textual images or graphic images, including photographs. In the case of an electric or digital display the image data could be stored in an onboard memory in the circuit board 2 and/or uploaded or updated by data transfer via the data transfer device.

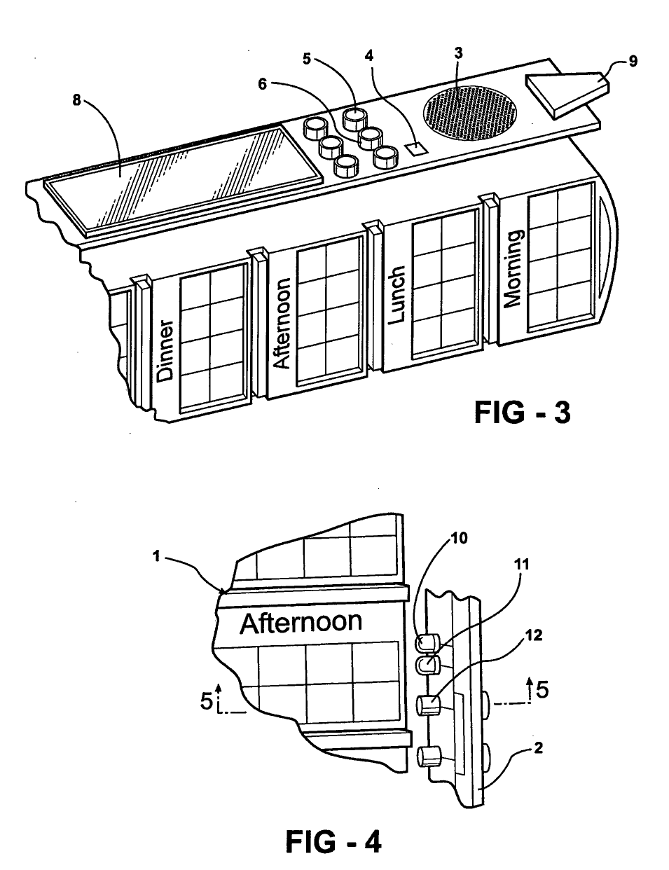

FIG. 3 is a side perspective view of one end of an electronic pillbox according to one embodiment of the present invention. One end of the circuit board 2 can be provided with a data scanning device 9 that can scan text, graphics, barcodes, etc. As one non-limiting example, the scanning device 9 could be used to scan information from a medicine container and store and/or display this information or a variation of this information on the display 8 and/or transfer this information via the data transfer device to another device, including a computer, other mobile devices, including cell phones, pagers, interactive testing devices, etc.

FIG. 4 is an enlarged exploded perspective view of an electronic pillbox according to one embodiment of the present invention. As shown in FIG. 4 (and FIG. 1), the circuit board 2 includes one or more LED's 10 and 11 and a sensor 12 which are positioned adjacent each of the compartments of the pillbox 1. In the illustrated embodiment, LED 10 produces a red light source and can be used to indicate that it is not time to take a medication contained in an adjacent compartment and LED 11 produces a green light source and can be use to indicate that it is time to take a medication contained in an adjacent compartment. The sensor 12, as discussed below is used to sense when a cover of an adjacent compartment has been opened. It will be understood from the following description that various types of sensors can be used for this purpose, including proximity sensors, optical sensors, magnetic sensors, etc.

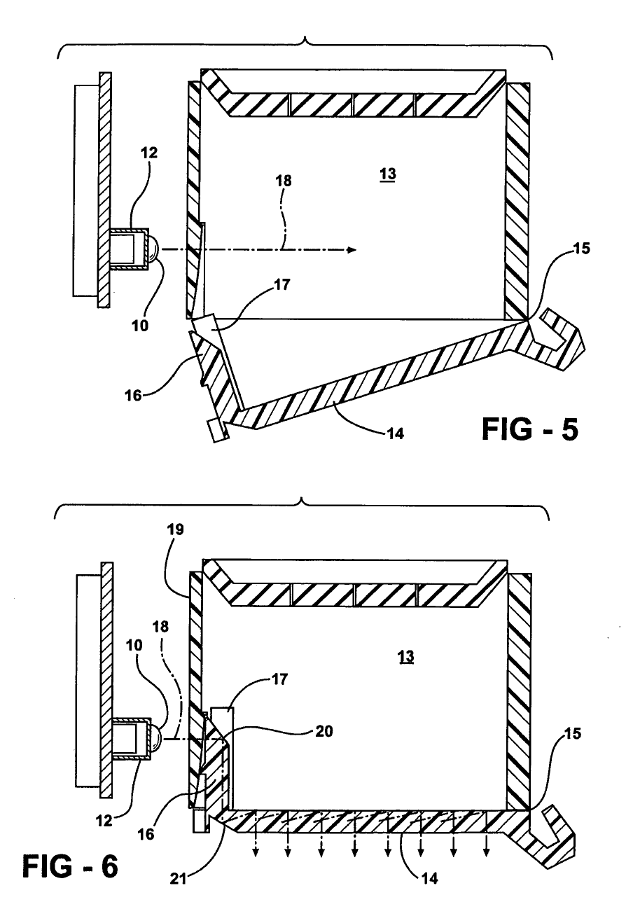

FIG. 5 is cross-sectional view of the electronic pillbox of FIG. 4 taken along sectional lines 5-5. FIG. 5 depicts some of the structural elements of the pillbox compartments. Each compartment 13 of the pillbox 1 has a cover 14 that can be opened. In the depicted embodiment, the cover 14 is pivotal about a hinge 15. In other embodiments, the cover 14 can be configured to slide between open and closed positions. The cover 14 is designed to receive light via a light pipe 16 and illuminate. In this regard, the cover 14 can be made of a light conducting and dispersing material and can additionally be physically configured, e.g. formed with lens or other optical structures, to receive and distribute light and illuminate.

In the embodiment depicted in FIG. 5 the light pipe 16 has a magnet or magnetic material 17 on at least one adjacent side. This magnet material 17 can be sensed by sensor 12 when sensor 12 is a magnetic sensor.

FIG. 6 is a cross-sectional view of one of the compartments of an electronic pillbox of the present invention which depicts how the LED's illuminate the cover of a compartment. As depicted in FIG. 6, light 18 from the LED 10 is directed though the side wall 19 of compartment 13 so that it impinges on a first reflective angled surface 20 of light pipe 16. The side wall 19 of the compartment 13 can be transparent for this purpose. Otherwise, an aperture or through-hole (not shown) can be provided in the side wall 19 of compartment 13 to allow light to pass therethrough. The light 18 is directed by first reflective angled surface 20 so that is impinges a second angled surface 21. The second angled surface 21 can be configured to disperse and direct the light though the cover 14 so as to illuminate cover 14. The side or surface of the cover 14 that closest to the interior of compartment 13 can be provided with a reflective coating or layer so as to direct light or illumination to the outer surface of the cover 14 as depicted. Whereas only LED 10 is depicted in FIG. 6, it is to be understood that the other LED's (including LED 11) are each positioned and aligned to direct a different color light toward light pipe 16 and thereby illuminate cover 14 when cover 14 is closed. A program within the circuit board can thus control the illumination of the LED's for example by a timing circuit so that the covers of selective compartments can be illuminated with a desired light color at the times when a medication within the compartments should be taken. As can be understood, a processor on the circuit board can control the illumination of the covers on individual compartment covers in a variety of manners. For example, a given color can be continuously illuminated with a given color at the time when a medication is to be take and can flash a given color after the time a medication was suppose to have been taken when the electronic pillbox confirms that the medication has not been taken. In addition, or alternatively to the illumination alert, the electronic pillbox can provide an audible alert, message, etc.

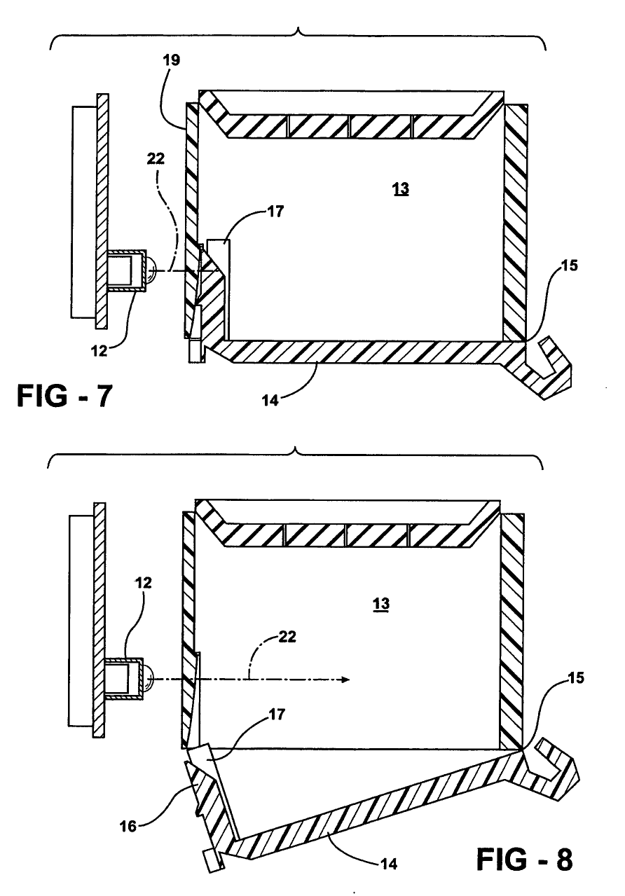

FIGS. 7 and 8 are cross-sectional views of one of the compartments of an electronic pillbox of the present invention which depict how the sensors 12 function to determine when the covers of the compartments have been opened. As depicted in FIGS. 7 and 8, radiation 22 from the sensor 12 is directed though the side wall 19 of compartment 13 so that it strikes light pipe 16. In the case where the cover 14 is closed as in FIG. 7, the radiation 22 or a portion thereof is reflected back after striking light pipe 16 and the reflected radiation 22 is detected by sensor 12. In the case where the cover 14 if opened as shown in FIG. 8, the radiation 22 does not reflect back toward sensor 12 so that the sensor 12 detects that the cover 14 is open.

By sensing or monitoring when a cover of a compartment has been opened, it can be determined or assumed that the medication within the compartment has been accessed and removed. Such removal of medication can further be determined or more reasonable assumed when the opening of a cover is correlated with illumination alerts of the cover of a compartment that signals a medication in a compartment should be taken (followed by confirmation that the cover of that compartment has been opened).

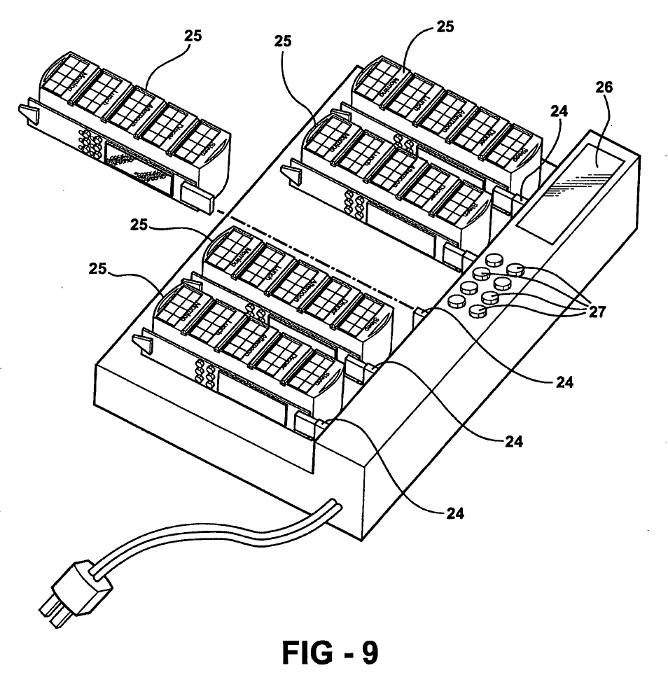

FIG. 9 is a perspective view of the electronic pillboxes positioned in a docking station according to one embodiment of the present invention. The docking station 23 includes a plurality of USB connectors 24 which are arranged to be coupled to a plurality of electronic pillboxes 25. Alternatively, other type of connectors such as pin connectors could be utilized. Otherwise, wireless connections can be provided. The docking station 23 includes a display 26 and either a plurality of buttons 27 or a control panel (not shown) which can be used to control the transfer of data between the individual electronic pillboxes 25 and the docking station 23 and the display of all data from either the docking station 23 and/or the individual electronic pillboxes 25. The docking station can be powered by a rechargeable or replaceable internal power supply and/or an electrical line that can be plugged into an external power supply.

The docking station can include a data transfer device such as a USB connection, pin connection, or wireless link and a programmable circuit to receive, transfer and correlate data between the electronic pillboxes 25 a computer, or mobile devices, including cell phones, pagers, interactive testing device, etc. directly or via the internet or cell phone transmission systems.

According to a further embodiment of the present invention, the circuit board 2 can include a circuit that can convert spoken information into textual information. In this embodiment, a person, such as a healthcare professional, can speak the name of a particular medication and/or instructions into the microphone 4 and a program incorporated into the circuit board 2 can translate the spoken information into textural or even graphic information and display the same on the displays of the electronic pillboxes 1, the display on the docking station 23 or store to a file for later retrieval. In addition, the translated spoken information can be transferred as a data file to a computer, mobile device such as a cell phone which can store and/or display the textural or graphical information.

According to another embodiment of the present invention the circuit board 2, in addition to transferring various data files to a computer, mobile device, the electronic pillboxes 1 of the present invention can send alerts to caregivers, family members, healthcare professionals, etc. that a patient has missed a dosage of medication has not been taken and/or prompt the caregivers, family members, healthcare professionals, etc., to remind the patient to take their medication at a designated time.

Although the present invention has been described with reference to particular means, materials and embodiments, from the foregoing description, one skilled in the art can easily ascertain the essential characteristics of the present invention and various changes and modifications can be made to adapt the various uses and characteristics without departing from the spirit and scope of the present invention as described above and as set forth in the attached claims.

What is claimed is:

1. An interactive electronic pillbox which comprises a housing having a plurality of compartments, each compartment defined by a top, an openable lid which closes the top, and a circuit board coupled to the pillbox, the circuit board including a plurality of light sources which can selectively illuminate individual ones of the plurality of compartments.

2. An interactive electronic pillbox according to claim 1, further comprising a speaker and microphone for recording and playing messages.

3. An interactive electronic pillbox according to claim 1, wherein the circuit board includes a program for converting spoken information into data that can be displayed as an image or stored in a file.

4. An interactive electronic pillbox according to claim 1, wherein the plurality of light sources selectively illuminate the covers of the plurality of compartments.

5. An interactive electronic pillbox according to claim 1, further comprising a display for displaying information.

6. An interactive electronic pillbox according to claim 5, wherein the display comprises an electronic display.

7. An interactive electronic pillbox according to claim 1, further comprising a plurality of sensors for sensing when covers of the plurality of compartments have been opened.

8. An interactive electronic pillbox according to claim 1, further comprising a data transfer device for transferring data between the interactive electronic pillbox and an auxiliary device.

9. An interactive electronic pillbox according to claim 1, further comprising a scanner for scanning textural information or images.

10. An interactive electronic pillbox according to claim 1, in combination with a docking station which docketing station is configured to receive a plurality of said interactive electronic pillboxes and transfer data between said plurality of interactive electronic pillboxes.

11. The combination of claim 10, wherein the docketing station comprises a display.

12. The combination of claim 10, wherein the docking station comprises a transfer device for transferring data between the docking station and an auxiliary device.

13. A method of managing an individual's healthcare which comprises:
providing an interactive electronic pillbox which includes a housing having a plurality of compartments, each compartment defined by a top, an openable lid which closes the top, and a circuit board coupled to the pillbox, the circuit board including a plurality of light sources which can selectively illuminate individual ones of the plurality of compartments;
providing medications in said plurality of compartments; and
illuminating a selected one of said plurality of compartments to indicate which medication is to be taken.

14. A method of managing an individual's healthcare according to claim 13, which further comprises:
providing the interactive electronic pillbox with a data transfer device; and
transferring data from the interactive electronic pillbox to a remote device.

15. A method of managing an individual's healthcare according to claim 14, further comprising allowing another party to monitor the data transferred to the remote device so as to monitor the individual's healthcare.

16. A method of managing an individual's healthcare according to claim 13, wherein the transferred data includes information regarding medications taken from the interactive electronic pillbox.

17. A method of managing an individual's healthcare according to claim 13, which further comprises:
providing the interactive electronic pillbox with a sound recording/playback means; and
recording healthcare management information with the interactive electronic pillbox.

18. A method of managing an individual's healthcare according to claim 13, wherein different colored lights are used to illuminate the compartments to indicate when a medication is to be taken from a particular compartment and at least one of i) when a medication should have been taken from a particular compartment and ii) when a medication is not to be taken from a particular compartment.

19. A method of managing an individual's healthcare which comprises:
providing an individual with an interactive electronic pillbox which includes a housing having a plurality of compartments;
providing medications in the at least some of the plurality of compartments;
transmitting data from the interactive electronic pillbox to a remote site; and
allowing another party to monitor the individual's healthcare from the data transmitted to the remote site.

20. A method of managing an individual's healthcare according to claim 19, wherein the transmitted data includes information as to whether or not the individual has taken medications on a predetermined schedule.
